(19) United States
(12) Patent Application Publication
(10) Pub. No.: US 2015/0022179 A1
(43) Pub. Date: Jan. 22, 2015

(54) VOLTAGE TRANSFORMER HAVING A FIRST PARALLEL CONNECTION

(71) Applicant: Gisbert Krauter, Burgstetten (DE)

(72) Inventor: Gisbert Krauter, Burgstetten (DE)

(21) Appl. No.: 14/355,771

(22) PCT Filed: Oct. 2, 2012
(86) PCT No.: PCT/EP2012/069393

§ 371 Date: May 1, 2014

(30) Foreign Application Priority Data
Nov. 2, 2011 (DE) 10 2011 085 559.9

(51) Int. Cl. H02M 3/06; H02M 3/08; H02M 3/04

(52) U.S. Cl. CPC H02M 3/06; H02M 3/04; H02M 3/08
USPC 323/364

(57) ABSTRACT

A voltage transformer is described, which includes a. first parallel connection of a first capacitor having a number of N>=1 actuators connected in parallel having N-input voltages and N-input currents. A second capacitor is connected to the first parallel connection in series, the capacitor voltage being lower than or equal to the lowest input voltage of the actuators.

### FIELD

The present invention relates to a voltage transformer including a first parallel connection of a first capacitor having a number of N>=1 actuators connected in parallel having N-input voltages and N-input currents. A second capacitor is connected to the first parallel connection in series, the capacitor voltage of the second capacitor being lower than or equal to the lowest input voltage of the actuators.

### BACKGROUND INFORMATION

In many applications, voltages must be transformed if the voltage source and the voltage sink have different voltages.

For that purpose, voltage transformers are frequently used for adjusting different voltage sources to a common potential.

In many applications, for example, in the case of photovoltaic power generation, the input voltages are of a similar level, but are not equal. Nonetheless, actuators are normally used which may be operated independently and therefore must be designed for the entire input voltage range. Since each source requires its own actuator in order to adjust the voltage and current range of the source, the design complexity for the actuators and accordingly the total costs as well as the power loss of the device are correspondingly high.

### SUMMARY

According to the present invention, a voltage transformer is provided, which includes a first parallel connection of a first capacitor having a number of N>=1 actuators connected. in parallel having N-input voltages and N-input currents. A second capacitor is connected to the first parallel connection in series, the capacitor voltage being lower than or equal to the lowest input voltage of the actuators.

Due to the parallel connection, the voltage transformer according to the present invention has the advantage that all elements have the same potential difference. Moreover, in the case of a parallel connection, individual elements may be advantageously added or removed without eliminating the other elements. The series connection also advantageously makes it possible that only that portion of the input voltage must be transformed which is different between the sources. It is not necessary to transform the portion of the voltage which is equal in all sources.

In one preferred embodiment of the present invention, it is provided that the voltage transformer has a regulator of such a type that on average the sum of the input currents of the actuators is equal to the sum of the output currents of the voltage transformer, and simultaneously the mean input power of the voltage transformers is equal to the mean output power of the voltage transformer.

In another preferred embodiment of the present invention, it is provided that the voltage transformer has a regulator of such a type that on average the energy remains constant in both capacitors.

The advantage of these two embodiments is that they improve the input circuit of the voltage transformer.

In another preferred embodiment of the present invention it is provided that the capacitor voltage of the first capacitor is at least as high as the highest input voltage minus the capacitor voltage of the second capacitor.

Through this embodiment, the voltage transformer according to the present invention very advantageously makes it possible that all actuators need only be designed to have components which are available for voltage U_{C1} and no longer for the entire intermediate circuit voltage U_{ZK1}=U_{C1}+U_{C2}.

In another preferred embodiment of the present invention, it is provided that the voltage transformer having an output stage is connectable to the series connection made up of the second capacitor and the first parallel connection via another actuator.

In another preferred embodiment of the present invention, it is provided that another actuator is connected to the series connection made up of the second capacitor and the first parallel connection in such a way that in a first configuration, the actuator voltage corresponds to the voltage across the second capacitor, and in a second configuration, it corresponds to the voltage across the series connection.

The voltage transformer according to the present invention has the advantage that this configuration of the actuators reduces the design complexity of the actuators and accordingly reduces the total costs of the device or the system.

In another preferred embodiment of the present invention, it is provided that the input currents are in each case coupled into the voltage transformer via an inductor, as well as a diode and/or a switch connected in parallel.

The advantage of this is that through the parallel connection, only the potential difference and not the total potential is present on all elements.

In another preferred embodiment of the present invention, it is provided that the actuators are designed as step-up choppers and/or step-down choppers.

This advantageously results in the generation of a higher output voltage, and/or the output voltage is lower than the constant voltage source at the input, and the switch is periodically opened and closed as a result. The actuators could also be designed in such a way that they are able to transform power in both directions or only in the reverse direction. The advantage in this case would be that the input actuators are converted into output actuators and the output actuators are converted into input actuators.

In another preferred embodiment of the present invention, it is provided that at least one actuator is designed as a two-quadrant actuator of such a type that the current is reversible and at least one input actuator functions as an output actuator.

In another preferred embodiment of the present invention, it is provided that the output voltage is dependent on the input variables.

This advantageously results in the generation of a uniformly flowing current over time, or a variation of the output current is possible.

In another preferred embodiment of the present invention, it is provided that the output voltage is varied in such a way that in the case of a series connection having a load, which requires a variable input voltage, the output voltage corresponds to the variable input voltage.

In another preferred embodiment of the present invention, the voltage transformer has a method for voltage transformation which includes the steps of providing a first parallel connection of a first capacitor with a number of N>=actuators connected in parallel to N-input voltages and N-input currents, and connecting a second capacitor in series to the first parallel connection, the second capacitor voltage being lower than or equal to the lowest input voltage of the actuators, and transforming the differential voltage difference of the N-input voltages.

In another preferred embodiment of the present invention, a method for voltage transformation is provided, which includes the step of designing the components of the first parallel connection for the first capacitor voltage.

Furthermore, through the two embodiments described above, the method for voltage transformation according to the present invention very advantageously may make it possible on the one hand to utilize the energy in the second capacitor if the output voltages of the actuator are low, while the input actuators charge the first capacitor. Subsequently, in the next time segment, at a higher output voltage, the energy in the first capacitor may be additionally utilized. Another advantage is that this configuration of the actuators may reduce the design complexity of the actuators and accordingly reduces the total costs of the device or the system while simultaneously increasing the efficiency.

This present invention is in particular suitable for use in photovoltaic inverters, preferably in single- and three-phase multistring photovoltaic inverters, for which product costs are significant.

Advantageous refinements of the present invention are explained in the description.

### BRIEF DESCRIPTION OF THE DRAWINGS

Exemplary embodiments of the present invention are depicted in the figures and explained in greater detail below.

FIG. 1 shows a schematic circuit diagram having two input currents and two output currents as well as two output voltages.

FIG. 2 shows a schematic circuit diagram having one output voltage and one output current.

FIG. 3 shows a schematic circuit diagram having a downstream actuator, which is fed from two different output voltages.

### DETAILED DESCRIPTION OF EXAMPLE EMBODIMENTS

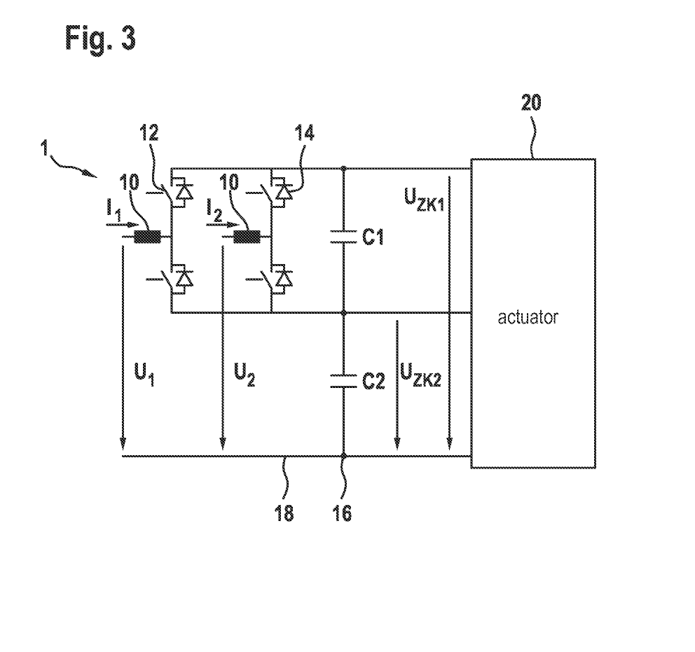

FIG. 1 shows a schematic circuit diagram of a voltage transformer 1. FIG. 1 is a specific embodiment of the input circuit of a voltage transformer 1 according to the present invention. Voltage transformer 1 has a first input current I₁ having a first. inductor 10, and first inductor 10 is connected to two diodes 14 and two switches 12 via a connecting line 18.

Depending on the operating mode, one switch and/or one diode may also be omitted. Moreover, voltage transformer 1 has a second input current I₂ having a second inductor 10 and second inductor 10 is also connected to two diodes 14 and two switches 12 via a connecting line 18. In addition to input currents I₁ and I₂, voltage transformer 1 also includes input voltages U₁ and U₂. The input voltage is the electrical voltage which is provided at the input of the electrical circuit from an external source. Capacitor C1 is connected to capacitor C2 by a connection point 16. Capacitors C1 and C2 store the electrical charge and the associated energy. These capacitors counteract voltage changes due to their charge storage capability, Voltage transformer 1 is made up of at least two input currents I₁ and I₂, which are connected in series to a is system of multiple actuators connected in parallel to a capacitor C1 and in series to a capacitor C2. Capacitor voltage U_{CZ} may not be higher than the lowest input voltage U₁ through Uₙ. Furthermore, capacitor voltage U_{C1} must be at least as high as the highest input voltage U₁ through Uₙ minus voltage U_{C2}. From this it may be inferred that all actuators need only be designed to have components which are present for voltage U_{C1}=U_{ZK1}−U_{ZK2} and no longer for entire intermediate circuit voltage U_{ZK1}=U_{C1}+U_{C2}. The actuators are connected in parallel, since all poles of the same polarity are each connected to one another. In the case of a parallel connection, all elements have the same potential difference. Moreover, in the case of a parallel connection, individual elements may be added or removed without eliminating the other elements. The series connection or connection in series is characterized in that the connection has no branching. The series connection also makes it possible to generate higher overall voltages if the polarity is correct.

Furthermore, a regulator ensures that on average the sum of the input currents is equal to the sum of the output currents and simultaneously the mean input power is equal to the mean. output power, i.e., I₁+I₂+ . . . +Iₙ=I_{ZK1}+I_{ZK2} and U₁*I₁+U₂* I₂+ . . . +Uₙ*Iₙ=U_{ZK1}*I_{ZK1}+U_{ZK2}*I_{ZK2}.

An expanded. circuit of a voltage transformer 1 is shown in FIG. 2. All circuit components which are retained without change have been provided with identical reference numerals as in FIG. 1. FIG. 2 differs from FIG. 1 in that in FIG. 2, any output stage is connectable to the two-level intermediate circuit via an output current I_{A}. The two-level intermediate circuit is used as an energy store. Moreover, FIG. 2 shows an output voltage U_{A}. Output voltage U_{A} may vary between voltage U_{ZK2} and U_{ZK1}; however, it is on average the case that: U₁*I₁+U₂*I₂+ . . . +Uₙ*Iₙ=U_{A}*I_{A}.

Another specific embodiment of the input circuit of a voltage transformer 1 according to the present invention is shown in FIG. 3. In this specific embodiment, only two selective circuits are used. The series connection of a greater number of selective circuits of this type is, however, easily possible. In this case also circuit components which are retained without change have been provided with identical reference numerals as in FIG. 1. In FIG. 3, the output stage is expanded in such a way that it is able to select between the two different input voltages U_{ZK1} and U_{ZK2}. In the case of an output voltage which is changeable over time, it is thus possible, in the case of low output voltages of actuator 20, to utilize the energy in C2, while the input currents charge capacitor C1. Subsequently, in the next time segment, at a higher output voltage, the energy in C1 may be additionally utilized. This configuration of actuator 20 in FIG. 3 causes actuator 20 to transform only the differential voltage difference but not the common portion. This makes it possible to reduce the design complexity for the actuators and accordingly the total costs of the device or system.

In its specific embodiment, the present invention is not limited to the above-described preferred exemplary embodiments. Instead, it also extends to variants and embodiments in which the present invention may be implemented.

1-13. (canceled)

14. A voltage transformer, comprising:
a first parallel connection of a first capacitor having a number of N>=1 actuators connected in parallel having N-input voltages and N-input currents; and
a second capacitor is connected to the first parallel connection in series, a capacitor voltage of the second capacitor being lower than or equal to a lowest one of the N-input voltages of the actuators.

15. The voltage transformer as recited in claim 14, wherein the voltage transformer has a regulator of such a type that on average a sum of the input currents of the actuators is equal to a sum of the output currents of the voltage transformer, and simultaneously a mean input power of the voltage transformer is equal to a mean output power of the voltage transformer.

16. The voltage transformer as recited in claim 14, wherein the voltage transformer has a regulator of such a type that on average the energy remains constant in both capacitors.

17. The voltage transformer as recited in claim 14, wherein a capacitor voltage of the first capacitor is at least as high as a highest of the N-input voltages minus the capacitor voltage of the second capacitor.

18. The voltage transformer as recited in claim 14, wherein an output stage is connectable to the series connection made up of the second capacitor and the first parallel connection via another actuator.

19. The voltage transformer as recited in claim 14, comprising:
another actuator connected to the series connection made up of the second capacitor and the first parallel connection in such a way that in a first configuration, an actuator voltage corresponds to the capacitor voltage across the second capacitor, and in a second configuration, the actuator voltage corresponds to a voltage across the series connection.

20. The voltage transformer as recited in claim 14, wherein the input currents are in each case coupled into the voltage transformer via an inductor, and at least one of: i) a diode, and ii) a switch connected in parallel.

21. The voltage transformer as recited in claim 14, wherein the actuators are at least one of: i) step-up choppers, and ii) step-down choppers.

22. The voltage transformer as recited in claim 14, wherein at least one of the actuators is designed as a two-quadrant actuator of such a type that current of the at least one of the actuators is reversible and at least one input actuator functions as an output actuator.

23. The voltage transformer as recited in claim 14, wherein an output voltage of the voltage transformer is dependent on input variables.

24. The voltage transformer as recited in claim 14, wherein an output voltage of the voltage transformer is varied in such a way that in the case of a series connection having a load, which requires a variable input voltage, the output voltage corresponds to the variable input voltage.

25. A method for voltage transformation, comprising:
providing a first parallel connection of a first capacitor with a number of N>=1 actuators connected in parallel to N-input voltages and N-input currents;
connecting a second capacitor in series to the first parallel connection, the second capacitor voltage being lower than or equal to a lowest one of the input voltages of the actuators; and
transforming differential voltage difference of the N-input voltages.

26. A method for voltage transformation as recited in claim 25, further comprising:
designing components of the first parallel connection for the first capacitor voltage.
